(19) United States
(12) Patent Application Publication
(10) Pub. No.: US 2010/0084497 A1
(43) Pub. Date: Apr. 8, 2010

(54) Grating for mincer

(75) Inventor: Jacques Le Paih, Plumeliau (FR)

Correspondence Address: ZARLEY LAW FIRM P.L.C., CAPITAL SQUARE, 400 LOCUST, SUITE 200, DES MOINES, IA, 50309-2350, US

(73) Assignee: Stork Food Systems France, Baud (FR)

(21) Appl. No.: 12/309,251

(22) PCT Filed: Jul. 10, 2007
(86) PCT No.: PCT/FR2007/001179

§ 371 Date: Apr. 3, 2009

(30) Foreign Application Priority Data
Jul. 11, 2006 (FR) 06.06341

(51) Int. Cl. A47J 43/00

(52) U.S. Cl. 241/83

(57) ABSTRACT

The present invention relates to a grating for a mincer comprising a plurality of extrusion holes for forming a stream of minced meat intended for preparing portions of minced meat, especially shaped portions such as minced meat steaks, and a device for producing portions of minced meat, comprising a mincer equipped with such a grating. The grating (201) comprises holes (221, 222, 223, 224), whose axes in vertical and/or horizontal projection, have different orientations so that the strings of meat (F) extruded through said holes intertwine.

The present invention relates to a grating for a mincer and a device for preparing portions of minced meat comprising a mincer equipped with such a grating.

There has been known especially from patent document FR 2 718 612 devices for preparing minced meat steaks comprising a mincer for outputting a sausage or a stream of minced meat, conveyor means for transporting said stream of minced meat at the output of the mincer, and along said conveyor means, means for cutting the said stream of minced meat into portions. The mincer is classically equipped with a grating of generally circular shape, with straight holes or perforations, the axes of which being oriented in parallel to the grating's central axis. The holes are arranged in superimposed rows on a rectangular area of the grating in order to circumscribe a form of stream of determined size and volume depending on the steaks to be obtained. The strings or strands of meat extruded through the grating are in the shape of superimposed layers corresponding to the rows of straight holes.

The minced meat steaks formed from such a stream may tend to come undone before and/or after cooking, particularly when one tries to minimize the force applied on the stream for the shaping of the steaks.

At the output the strands are arranged parallely to each other in the stream's feed direction. The pieces or fibers of meat composing the stream are thus all substantially oriented in the same direction. Upon cooking, the fibers of meat mainly retract in one direction resulting in a deformation of the steak.

Moreover, so as not to have a stream of straight parallel strings and to obtain a better final aspect of the product, the stream of meat is classically output on a conveyor driven at a lower speed than that of the output of meat from the grating, such that the layers of strings arriving on the conveyor crease, and form waves. These waves are irregular and are more or less slanted in the conveyor's feed direction or in the opposite direction. Although a substantially constant output of meat may be obtained at the mincer's output, the quantity of minced meat along the stream may vary due to these irregular waves of the layers. The weight of the portions shaped from such a stream of meat can thus vary greatly with respect to the target average weight. With regard to the marketing aspect, it is necessary to guarantee a substantially constant unit weight corresponding to the advertised weight. The manufacturer is thus required to increase the target average weight so as to be sure to achieve the advertised weight, thus leading to important losses of products for the manufacturer.

The purpose of the present invention is to provide a solution for overcoming the aforementioned drawbacks.

With this regard, the present invention relates to a perforated grating for a mincer comprising a plurality of extrusion holes for forming a stream of minced meat intended for preparing portions of minced meat, especially shaped portions such as minced meat steaks, characterized in that said grating comprises holes, whose axes in vertical and/or horizontal projection, have different orientations so that the strings of meat extruded through said holes intertwine.

The grating according to the invention comprises oblique holes whose axes have different orientations. The stream of meat outputted from such a grating is formed by a more compact mass of meat exhibiting a better firmness. The stream of meat does not crease randomly anymore as in the prior art, thus enabling a portioning at a substantially constant weight. In the case of a mincer outputting a stream of meat at a higher speed than that of the conveyor whereon said stream of meat is placed, the compact stream of meat tends to expand homogenously in all directions.

According to a particularity, the grating comprises at least holes whose axes have different orientations in horizontal projection, preferably opposite orientations in horizontal projection, such that the strings of meat are not all oriented anymore in the longitudinal direction of the stream of meat.

According to a particularity, the holes are arranged in horizontal superimposed rows in order to form for example a stream of a substantially rectangular cross-section, the axes of holes of two successive rows having different orientations in vertical and/or horizontal projection, and/or the axes of holes of a same row having different orientations in vertical and/or horizontal projection. Advantageously, the holes of two successive rows are arranged in staggered rows.

According to embodiments, the grating exhibits a thickness of 8 to 20 mm, and/or comprises from 50 to 200 holes, and/or comprises holes of circular cross-section, having a diameter ranging between 2 and 7 mm.

The invention also relates to a device for preparing portions of minced meat, comprising a mincer for outputting a stream of minced meat, which stream of minced meat has a thickness determined according to the portions to be produced, endless belt conveyor means for transporting said stream of minced meat at the output of said mincer, and along said conveyor means, means for cutting said stream of minced meat into portions, the device being characterized in that said mincer is equipped with a grating such as defined previously.

According to a particularity, for preparing portions of minced meat shaped as minced meat steaks, the device further comprises, along said conveyor means, shaping means acting on said stream of minced meat for shaping the portions, especially lateral shaping means simultaneously acting on each side of said stream of minced meat in order to shape the outline of said portions, and vertical shaping means cooperating with said lateral shaping means for providing the portions with the required thickness.

The invention will be better understood and other objects, details, features and advantages will become more apparent throughout the following detailed explanatory description of the currently preferred particular embodiment of the invention, with reference to the accompanying schematic drawings, in which

FIG. 1 shows a front view of a grating according to a first embodiment of the invention;

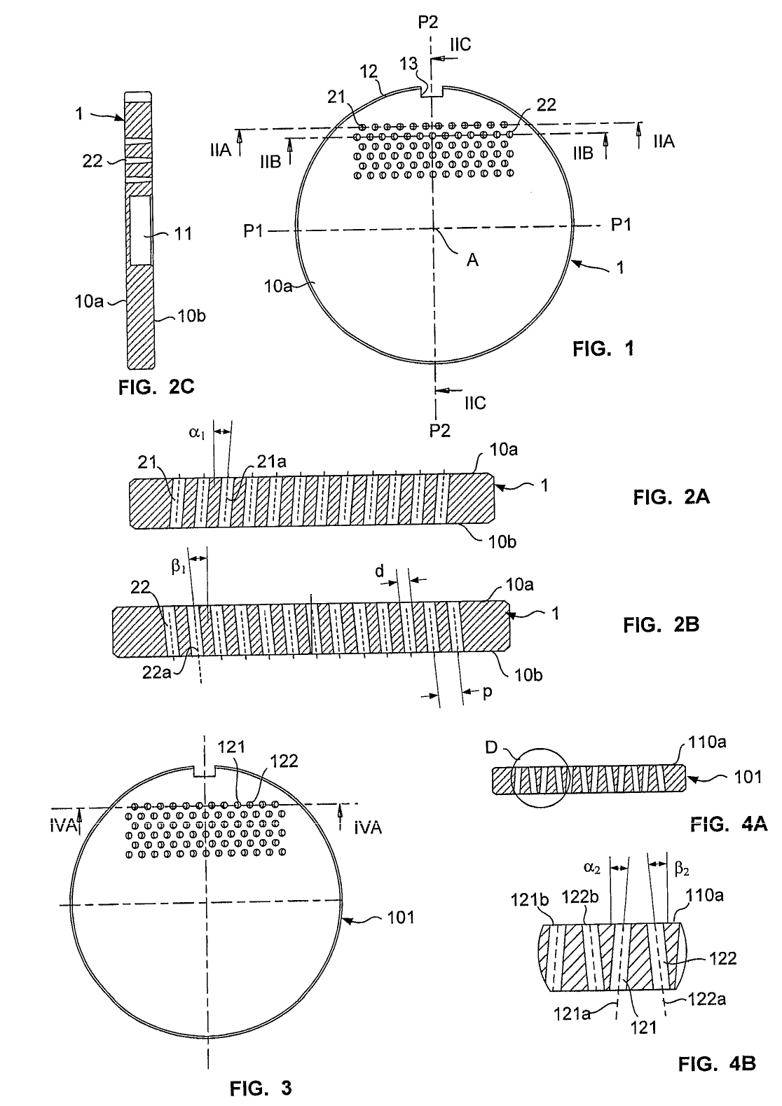

FIGS. 2A, 2B and 2C respectively show enlarged views according to cutting plans IIA-IIA, IIB-IIB, and IIC-IIC of FIG. 1;

FIG. 3 shows a front view of a grating according to a second embodiment of the invention;

FIG. 4A shows a view according to cutting plan IVA-IVA;

FIG. 4B is an enlarged view of detail D in FIG. 4A;

FIG. 5 shows a front view of a grating according to a third embodiment, whereon a few strands of meat extruded through holes are schematically illustrated;

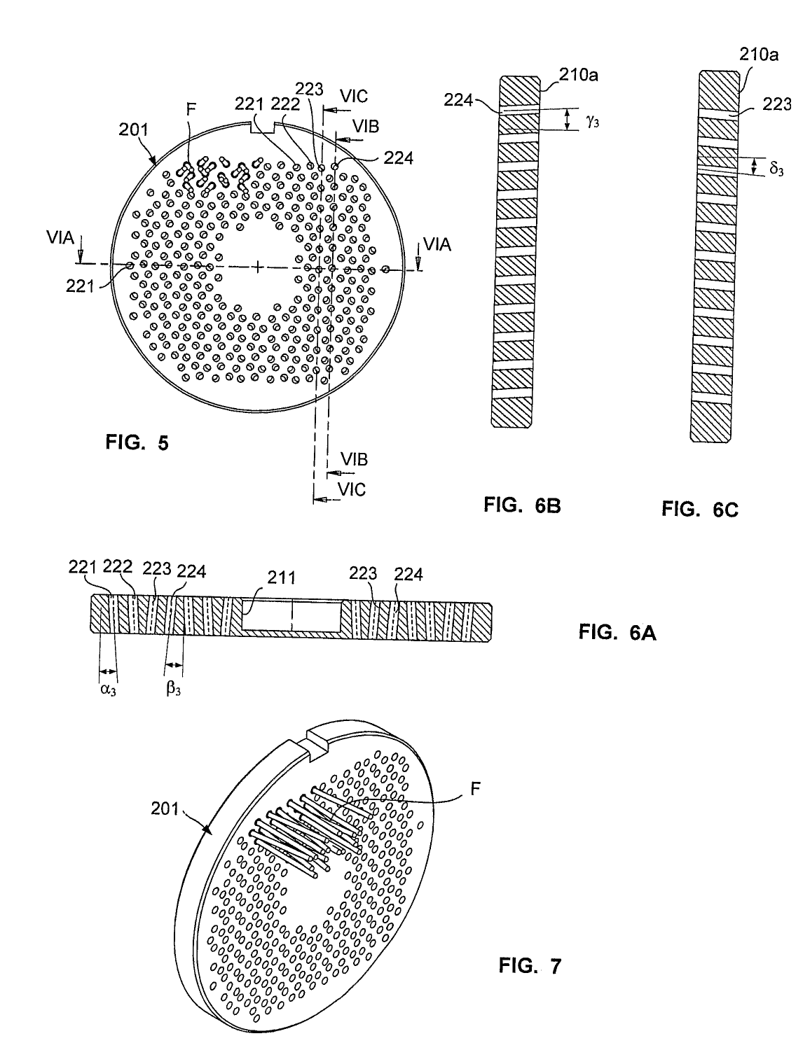

FIGS. 6A, 6B and 6C respectively show enlarged views according to cutting plans VIA-VIA, VIB-VIB, and VIC-VIC of FIG. 5;

FIG. 7 shows a perspective view of the grating of FIG. 5; and,

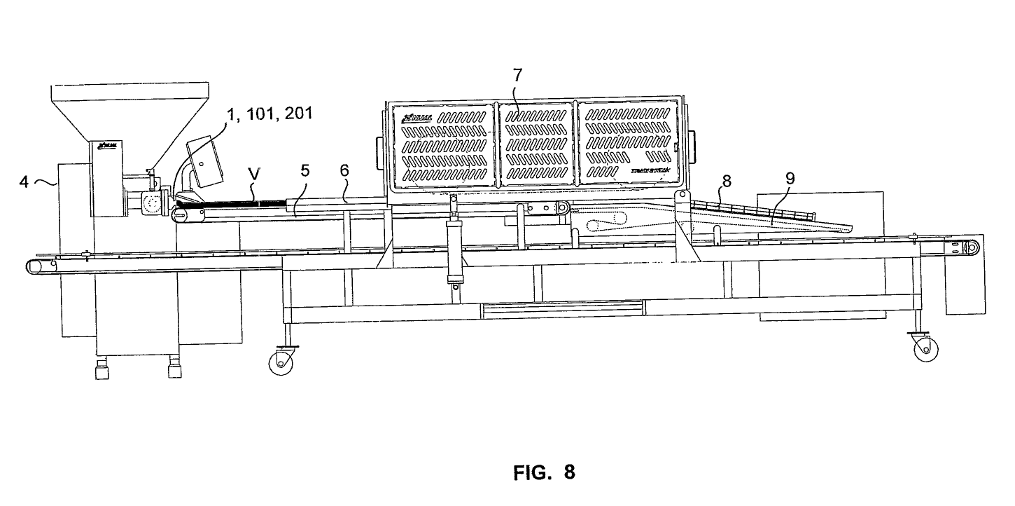

FIG. 8 is a schematic side view of a device for preparing minced meat steaks, comprising a mincer equipped with a grating according to the invention.

In reference to FIGS. 1 and 2C, the grating 1 is formed by a disk of main axis A1, provided with through holes opening onto each main face 10a, 10b of the disk. The grating is intended to be classically mounted on a mincer particularly for extruding strands of minced meat. The said rear main face 10b, whereby said grating is intended to abut against the mincer, exhibits an axial bore 11 for receiving the end of the shaft bearing the mincer's knifes. The grating exhibits on its periphery 12 an upper notch 13 for its rotational locking on the mincer.

Holes 21, 22 are arranged according to horizontal superimposed rows, the holes of two successive superimposed rows being arranged in staggered rows. Such as shown in FIG. 1, the grating comprises alternated first rows of holes 21, whose axes are oriented to the right, and second rows of holes 22, whose axes are oriented to the left.

In reference to FIG. 2A, the axes 21a of holes 21 of a first row are parallel to each other and form a non-null angle α₁ with respect to the normal to the grating's plan. In reference to FIG. 2B, the axes 22a of holes 22 of a second row are parallel to each other and form a non-null angle β₁ with respect to the normal, the angle β₁ being opposite to angle α₁, such that β₁=−α₁. The axes of the holes thus exhibit in horizontal projection, for example according to plan P1, different orientations from one row to the other, the holes' axes having in vertical projection, according to plan P2, identical orientations parallel to the main axis, as can be seen from FIG. 2C.

By way of example, the grating has a thickness of about 12.5 mm and a diameter of about 130 mm. The angle α₁ is for example of 5°. The holes of the different rows have identical circular sections, for example of diameter d of 3 mm. The spacing pitches p between the holes 21, 22 are identical from one row to the other, of 6 mm for example.

The grating makes it possible to form at the output a stream of minced meat formed by layers of parallel superimposed strings, with alternated layers comprising parallel strings oriented to the left and layers of parallel strings oriented to the right.

In the present embodiment, the holes are only arranged in the upper half of the grating, between the main axis A and the bore 11 along 6 rows. This grating is more specifically intended for preparing minced meat steaks, for which extruding the meat through holes arranged below the knife' axis is avoided, in order to guarantee a constant output.

In an alternative embodiment, the grating comprises alternating first rows comprising holes oriented upwards and second rows of holes oriented downwards, the axes of the holes thus exhibiting in vertical projection different orientations from one row to the other, and are all oriented parallel to the normal to the grating in horizontal projection.

In the embodiment shown in FIGS. 3, 4A and 4B, the grating 101 comprises holes 121, 122 arranged in staggered rows along identical superimposed horizontal rows. Each row is formed with a succession of pairs of holes 121, 122, each pair comprising a first hole 121, the axis 121a of which is oriented to the right, forming an angle α₂ with respect to the normal to the grating plan, and a second hole 122, axis 122a of which is oriented to the left, forming an angle β₂ with respect to the normal, such that the two strands extruded through the holes of a pair are convergent towards each other. The output ports 121b, 122b of the holes on the front main face 110a of the grating are arranged at regular intervals, the spacing pitch between the ports being for example of 6 mm as stated before.

FIGS. 5, 6A-C and 7 show a third embodiment wherein the grating comprises horizontal rows of superimposed holes, each row comprising sets of four types of different holes 221-224. In reference to FIG. 6A, the first hole 221 and the second hole 222 have their axis oriented to the right, with an angle α₃ to the normal in horizontal projection, and the third and fourth holes 223 and 224 have their axis oriented to the left in horizontal projection at an angle β₃ equal to −α₃.

In reference to FIG. 6B, the axes of the fourth holes 224 are oriented upwards at an angle γ₃ in vertical projection. The axes of the second holes are also oriented upwards at a same angle γ₃ in vertical projection.

In reference to FIG. 6C, the axes of the third holes 223 are oriented downwards at an angle δ₃ in vertical projection. The axes of the second holes are also oriented upwards at an angle δ₃ in vertical projection.

Thus, seen from the front face 210a, as shown in FIG. 1, each set of holes of a row comprises successively, from left to right, a first hole 221 oriented downwards and towards the right, a second hole 222 oriented upwards and towards the right, a third hole 223 oriented towards the left and downwards and a fourth hole 224 oriented to the left and upwards.

The grating 201 comprises a vertical alternation of first horizontal rows and second horizontal rows, the same-type holes of the first rows being vertically aligned, the second rows also having vertically aligned same-type holes. The holes of the first rows and second rows are shifted such that the vertical alignments of the first holes 221 of the second rows are arranged between the vertical alignments of the third holes 223 and fourth holes 224 of the first rows.

In this embodiment, the rows of holes extend around the central bore 211 on the upper half and the lower half of the grating. FIG. 7 schematically shows the interleaving of the strings F of meat obtained at the output of such a grating.

FIG. 8 represents a device for preparing minced meat steaks, comprising a mincer 4 equipped with a grating 1, 101, 201 according to the invention for outputting a stream V on the upper part of a first endless belt conveyor 5. Advantageously, the output of meat at the grating's output is slightly higher than the first conveyor's forward speed. The device comprises along this first conveyor, a cutting system 6 for cutting the stream into portions, then a shaping system 7 of said portions, downstream of which the shaped portions are transferred into package trays 8 running on a second endless belt conveyor 9. By way of example, the device comprises the shaping and cutting systems described in patent document FR 2 826 237.

Although the invention has been described in connection with particular embodiments, it is to be understood that the invention is in no way limited to the disclosed embodiments and that it comprises all technical equivalents of the described means as well as their combinations should these combinations fall within the scope of the invention.

1. Perforated grating of a mincer comprising a plurality of extrusion holes for forming a stream of minced meat intended for preparing portions of minced meat, particularly shaped portions such as minced meat steaks, characterized in that the holes are arranged in superimposed horizontal rows, the axes (21a, 22a; 121a, 122a) of holes (21, 22; 121, 122; 221, 222, 223, 224) of a same row and/or of two successive rows having opposite orientations in horizontal projection, such that the strings (F) of meat extruded through said holes intertwine.

2. The grating according to claim 1, characterized in that the axes of holes of two successive rows have opposite orientations in horizontal projection.

3. The grating according to claim 1, characterized in that each row comprises pairs of holes whose axes have opposite orientations in horizontal projection.

4. The grating according to claim 1, characterized in that it comprises holes of a same row and/or two successive rows whose axes have opposite orientations in horizontal projection and vertical projection.

5. The grating according to claim 1, characterized in that the holes of two successive rows are arranged in staggered rows.

6. The grating according to claim 1, characterized in that it exhibits a thickness of 8 to 20 mm.

7. The grating according to claim 1, characterized in that it comprises from 50 to 200 holes.

8. The grating according to claim 1, characterized in that it comprises holes of circular cross-section, having a diameter comprised between 2 and 7 mm.

9. A device for preparing portions of minced meat, comprising a mincer for outputting a stream of minced meat, endless belt conveyor means for transporting said stream of minced meat at the output of said mincer, and along said conveyor means, means for cutting said stream of minced meat into portions, characterized in that said mincer is equipped with an output grating according to claim 1.

10. The device according to claim 9 for preparing shaped portions of meat such as minced meat steaks, characterized in that it further comprises, along said conveyor means (5), shaping means (7) acting on said stream (V) of minced meat for shaping the portions.
